(19) United States
(12) Patent Application Publication
(10) Pub. No.: US 2003/0162574 A1
(43) Pub. Date: Aug. 28, 2003

(54) Mobile phone charger charged by battery

(76) Inventor: Jia-Hua Fan, Gung-Guan Hsiang (TW)

Correspondence Address: Keith Kline, PRO-TECHTOR INTERNATIONAL SERVICES, 20775 Norada Court, Saratoga, CA, 95070-3018, US

(21) Appl. No.: 10/085,206

(22) Filed: Feb. 26, 2002

(51) Int. Cl. H04M 1/00

(52) U.S. Cl. 455/573; 455/572

(57) ABSTRACT

As suggested by its name, the present invention makes use of battery, which is available across the world, as the source of electricity for charging mobile phones. The DC stabilization circuit and stabilizer circuit adjust the voltage of battery to the desired level. The charger circuit and charger loop transmit the stabilized electricity to the mobile phone battery. The circuit protector disconnects the charging automatically as soon as the mobile phone battery if fully charged in order to protect the mobile phone battery from being over-charged and damaged. The present invention allows users to charge their mobile phones anytime and anywhere. No receptacle is needed. The present invention is free from the restriction of electricity supply and is, therefore, a competitive and practical accessory for mobile phone users.

### BACKGROUND OF THE INVENTION

1. Field of the Invention

The present invention relates to a mobile phone charger charged by battery available all over the world and easy to carry, thereby allows users to charge their mobile phones anytime and anywhere.

2. Description of the Prior Art

A mobile phone charger charged by battery enables users to charge their mobile phones at all locations by batteries that they can purchase anywhere. With the present invention, users can charge their mobile phones anywhere they are.

### SUMMARY OF THE INVENTION

Batteries are indispensable for the reception/transmission of signals and communication of mobile phones. The mobile phones are charged through a charger connecting to the receptacles. If users are out of homes or camping, they have no access to household power supply and, therefore, cannot charge their mobile phones. Another problem is the receptacle. Users find that most countries make their own models of plugs and cannot charge their mobile phones via the receptacles when they are in foreign countries. These problems really bother mobile phone users.

The inventor of present invention had studied these problems thoroughly and hopes that the present invention can help the mobile phone users across the world.

The present invention will be apparent in its contents of technique after reading the detailed description of the preferred embodiments of the present invention in reference to the accompanying drawings, wherein:

### BRIEF DESCRIPTION OF THE DRAWINGS

FIG. 1 is a perspective view showing the structure of present invention;

FIG. 2 is a perspective view showing the circuit structure of present invention.

### DETAILED DESCRIPTION OF THE PREFERRED EMBODIMENT

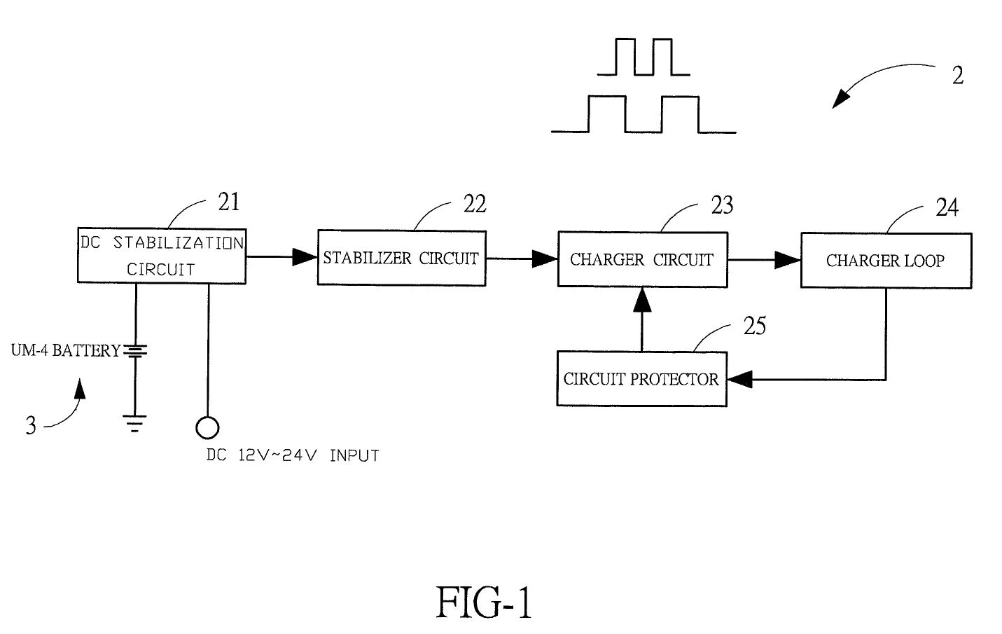

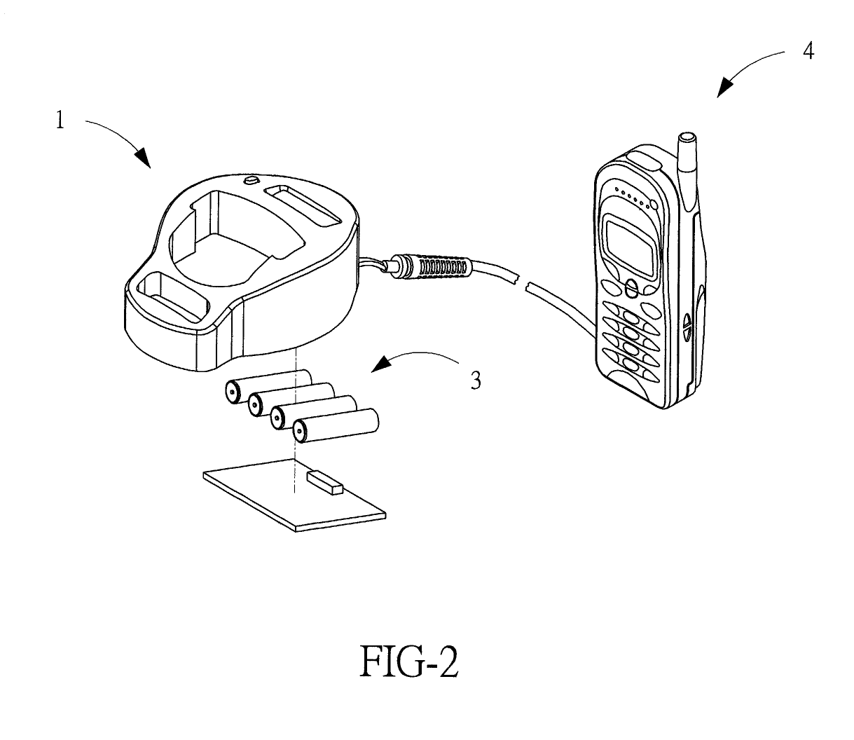

As shown by FIG. 1 and FIG. 2, there are a central circuit 2 and a battery 3 provided in the charger 1; and the charger 1 connects to the mobile phone battery 4; thereby allows the battery 3 to transfer and transmit the electricity to the mobile phone battery 4.

The central circuit 2 consists of a DC stabilization circuit 21, stabilizer circuit 22, charger circuit 23, charger loop 24, and circuit protector 25. The DC stabilization circuit 21 and stabilizer circuit 22 adjust and stabilize the voltage of battery 3 to the desired level. The charger circuit 23 and charger loop 24 transmit the stabilized electricity to the mobile phone battery 4. The circuit protector 25 disconnects the charging automatically as soon as the mobile phone battery 24 if fully charged in order to protect the mobile phone battery 4 from being over-charged and damaged.

When the mobile phone battery 4 is out of electricity, users may place the battery 3 in the charger 1 and connect the mobile phone battery 4 to the charger 1; then the mobile phone battery 4 will be charged. As soon as the mobile phone 4 is fully charged, the charging stops automatically.

Apparently, the present invention has the distinctive features as follows:

1. Whenever users have no access to household electricity or receptacles, such as hiking and camping, all they need are batteries and the charger stated in the present invention; then they can charge their mobile phones anytime and anywhere with no restrictions at all.

2. When out of countries, users can charge their mobile phones by batteries and the charger stated in the present invention anytime and anywhere; without using receptacles made in various models across the world.

In addition to the battery 3, the household DC and car lighter DC are also electricity sources for the charger 1 of present invention. The charger 1 can be used to charge either mobile phone or battery. The charger 1 can be connected to the mobile phone directly; or connected via a signal line.

As stated in the preceding paragraphs, the present invention is free from restrictions and can be used anywhere and anytime and is, therefore, a practical and ideal accessory for mobile phone users.

Having thus described my invention, what the inventor claims as new and desire to be secured by Letters Patent of the United States are:

1. A mobile phone charger charged by battery that provides a central circuit and battery in a charger connecting to mobile phone battery. The central circuit transforms and transmits the electricity of the battery to the mobile phone battery. The general circuit consists of a DC stabilization circuit, a stabilizer circuit, a charger circuit, a charger loop, and a circuit protector. The DC stabilization circuit and stabilizer circuit adjust the voltage of battery to the desired level. The charger circuit and charger loop transmit the stabilized electricity to the mobile phone battery. The circuit protector disconnects the charging automatically as soon as the mobile phone battery if fully charged in order to protect the mobile phone battery from being over-charged and damaged.

2. A mobile phone charger charged by battery as stated in claim 1, the household DC and car lighter DC are also electricity sources for the charger of present invention, in addition to the battery.

3. A mobile phone charger charged by battery as stated in claim 1, the charger can be used to charge either mobile phone or battery.

4. A mobile phone charger charged by battery as stated in claim 1, the charger can be connected to the mobile phone directly; or connected via a signal line.
